(19) United States
(12) Patent Application Publication
(10) Pub. No.: US 2019/0245198 A1
(43) Pub. Date: Aug. 8, 2019

(54) N-doped Si/C COMPOSITE AND MANUFACTURING METHOD THEREOF

(71) Applicant: GET Green Energy Corp., Ltd., Taichung City (TW)

(72) Inventors: Wei-Jen Liu, Taoyuan City (TW); Cheng-Che Hsieh, Taoyuan City (TW); Jiann-Yih Yeh, Changhua County (TW); Shin-Lee Liu, Pingtung County (TW)

(73) Assignee: GET Green Energy Corp., Ltd., Taichung City (TW)

(21) Appl. No.: 16/102,751

(22) Filed: Aug. 14, 2018

(30) Foreign Application Priority Data
Feb. 7, 2018 (TW) 107104396

(51) Int. Cl. H01M 4/1393; H01M 10/0525; B32B 9/00; C01B 32/22

(52) U.S. Cl. CPC H01M 4/1393; H01M 10/0525; H01M 2004/027; C01B 32/22; B32B 9/007

(57) ABSTRACT

A N-doped Si/C composite and a manufacture method thereof are provided. The N-doped Si/C composite includes a plurality of carbon-silicon particles. Each of the plurality of carbon-silicon particles includes one or more silicon particles and a carbon coating layer covering the one or more silicon particles, wherein a plurality of first nitrogen atoms is distributed in the one or more silicon particles of each carbon-silicon particle via a silicon-nitrogen bond, and a plurality of second nitrogen atoms is distributed in the carbon coating layer of each carbon-silicon particle via a nitrogen-carbon bond.

### CROSS-REFERENCE TO RELATED APPLICATION

This application claims the priority benefit of Taiwan application serial no. 107104396, filed on Feb. 7, 2018. The entirety of the above-mentioned patent application is hereby incorporated by reference herein and made a part of this specification.

### BACKGROUND OF THE INVENTION

### Field of the Invention

The invention relates to a N-doped Si/C composite and a manufacturing method thereof, and in particular, to a N-doped Si/C composite applied in the anode material of a lithium battery and a manufacturing method thereof.

### Description of Related Art

Currently, the anode material of a lithium ion battery is mainly a carbon material such as MCMB graphite (300 mAh/g-340 mAh/g) and graphene, and these carbon materials have good electrochemical stability and cycle life. With the development of current portable electronic devices and electric cars, a chargeable lithium ion battery requires better high-power output capacity.

However, lithium ions still move in and out of graphene in a mass transfer control process, and an ordered and dense graphene layer structure limits the charge and discharge capacity of the material. Moreover, IR drop caused by high-speed charge and discharge also causes the graphite material at a low reaction potential platform (0.1 V to 0.2 V) to not be able to achieve a deeper charging depth under a full-battery charge and discharge condition, such that the overall energy storage feature is affected.

Moreover, in recent years, hard carbon applied in electric cars has been developed, but the material has an amorphous structure such that the lithium ions have a higher mass transfer rate, so as to achieve rapid charging. However, structural defects of the material cause issues such as lower gram capacity (about 280 mAh/g) and irreversible capacitance (about 20%).

Based on the above, the development of both a microstructure design having a carbon-based material and structural integrity to meet the rapid charging feature, charge and discharge efficiency, gram capacitance, irreversible capacitance, conductivity, and cyclic stability of the anode material is an important topic requiring research.

### SUMMARY OF THE INVENTION

The invention provides a N-doped Si/C composite and a manufacturing method thereof, wherein the N-doped Si/C composite has good charge-discharge efficiency, high cyclic stability, and high conductivity, and is suitable for the anode material of a lithium battery. In particular, in the invention, in addition to performing nitrogen-doping on carbon, nitrogen-doping is further performed on silicon, and the results show that nitrogen atoms can be bonded to silicon atoms or carbon atoms. As a result, the N-doped Si/C composite has good charge-discharge efficiency, high cyclic stability, and high conductivity.

A N-doped Si/C composite and a manufacture method thereof are provided. The N-doped Si/C composite includes a plurality of carbon-silicon particles. Each of the plurality of carbon-silicon particles includes one or more silicon particles and a carbon coating layer covering the one or more silicon particles, wherein a plurality of first nitrogen atoms is distributed in the one or more silicon particles of each carbon-silicon particle via a silicon-nitrogen bond, and a plurality of second nitrogen atoms is distributed in the carbon coating layer of each carbon-silicon particle via a nitrogen-carbon bond.

In an embodiment of the invention, the nitrogen-carbon bond is pyridinic N, pyrrolic N, or graphitic-N.

In an embodiment of the invention, a peak position of the silicon-nitrogen bond in a silicon bond graph measured by the X-ray photoelectron spectroscopy is 94 eV to 108 eV.

In an embodiment of the invention, the nitrogen content of the N-doped Si/C composite is 0.05 wt % to 10 wt %.

The invention further provides a manufacturing method of a N-doped Si/C composite. A nitrogen-containing precursor, a carbon source, and a silicon source are mixed to provide a mixture; and the mixture is sintered in an inert atmosphere to obtain a N-doped Si/C composite. The N-doped Si/C composite includes a plurality of carbon-silicon particles. Each of the plurality of carbon-silicon particles includes one or more silicon particles and a carbon coating layer covering the one or more silicon particles, wherein a plurality of first nitrogen atoms is distributed in the one or more silicon particles of each carbon-silicon particle via a silicon-nitrogen bond, and a plurality of second nitrogen atoms is distributed in the carbon coating layer of each carbon-silicon particle via a nitrogen-carbon bond.

In an embodiment of the invention, the nitrogen-containing precursor is at least one selected from the group consisting of hexamethylenetetramine (C₆H₁₂N₄), ammonium benzoate (C₆H₅COONH₄), ammonium citrate (HOC(CO₂NH₄)(CH₂CO₂NH₄)₂), ammonium formate (NH₄HCO₂), naphthonitrile (C₁₁H₇N), melamine (C₃H₆N₆), naphthalenedicarbonitrile (C₁₀H₆(CN₂)), 1,8-naphthalimide (C₁₂H₇NO₂), ammonium oxalate ((NH₄)₂C₂O₄), ammonium carbonate ((NH₄)₂CO₃), and ammonium nitrate (NH₄NO₃).

In an embodiment of the invention, the nitrogen-containing precursor is at least one selected from the group consisting of hexamethylenetetramine (C₆H₁₂N₄) and melamine (C₃H₆N₆).

In an embodiment of the invention, the silicon source is at least one selected from the group consisting of silicon powder, solar energy recycled silicon waste, wafer thinning mortar, silicon oxide, silicon source of abandoned plants, silicon carbide, and carbon-coated silicon.

In an embodiment of the invention, the weight ratio of the carbon in the carbon source and the silicon in the silicon source is 0.01 to 1.

In an embodiment of the invention, the weight ratio of the nitrogen-containing precursor and the carbon in the carbon source is 1 to 30.

In an embodiment of the invention, the weight ratio of the nitrogen-containing precursor and the carbon in the carbon source is 5 to 30.

Based on the above, the invention provides a N-doped Si/C composite, wherein silicon atoms and carbon atoms are doped with nitrogen at the same time, and nitrogen atoms can be bonded on the silicon atoms or the carbon atoms to provide a N-doped Si/C composite having good charge-discharge efficiency, high cyclic stability, and high conductivity. The invention further provides a manufacturing method of a N-doped Si/C composite. A nitrogen-containing precursor, a carbon source, and a silicon source are mixed in solid phase and sintered to obtain the N-doped Si/C composite.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic of a N-doped Si/C composite according to an embodiment of the invention.

FIG. 2 is the transmission electron microscope (TEM) image of experimental example 1.

FIG. 3 is the X-ray photoelectron spectroscopy (XPS) of experimental example 1, experimental example 2, and comparative example 1.

FIG. 4A is the silicon bond graph of comparative example 1.

FIG. 4B is the silicon bond map of experimental example 1.

FIG. 4C is the silicon bond map of experimental example 2.

FIG. 5A is the nitrogen bond map of experimental example 1.

FIG. 5B is the nitrogen bond map of experimental example 2.

FIG. 6 is a lithium ion battery cycle life test chart of experimental example 1, experimental example 2, and comparative example 2.

FIG. 7A is a 10-cycle charge-discharge schematic of the material of experimental example 1 applied in a lithium ion battery.

FIG. 7B is a 10-cycle charge-discharge schematic of the material of experimental example 2 applied in a lithium ion battery.

FIG. 7C is a 10-cycle charge-discharge schematic of the material of comparative example 2 applied in a lithium ion battery.

FIG. 8 is an AC impedance analysis of the materials of experimental example 1, experimental example 2, and comparative example 2 applied in a lithium ion battery.

FIG. 9 is a cyclic voltammogram of the materials of experimental example 1, experimental example 2, and comparative example 2 applied in a lithium ion battery.

FIG. 10 is a comparison chart of resistance value and conductivity of four-point probe measurement of experimental example 1, experimental example 2, and comparative example 2.

### DESCRIPTION OF THE EMBODIMENTS

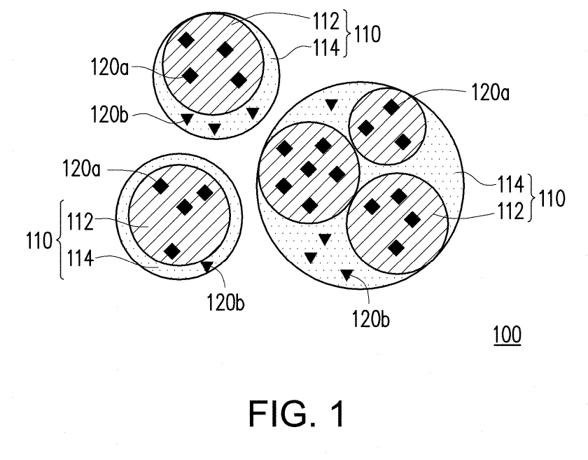

FIG. 1 is a schematic of a N-doped Si/C composite 100 according to an embodiment of the invention.

In the present embodiment, the N-doped Si/C composite 100 includes a plurality of carbon-silicon particles 110. Each of the plurality of carbon-silicon particles 110 includes one or a plurality of silicon particles 112 and a carbon coating layer 114, wherein the carbon coating layer 114 covers the one or a plurality of silicon particles 112. Nitrogen atoms are randomly distributed in the one or a plurality of silicon particles 112 and the carbon coating layer 114 of each of the carbon-silicon particles 110. Specifically, a plurality of first nitrogen atoms 120a is randomly distributed in the one or a plurality of silicon particles 112 of each of the carbon-silicon particles 110 via a silicon-nitrogen bond. A plurality of second nitrogen atoms 120b is randomly distributed in the carbon coating layer 114 of each of the carbon-silicon particles 110 via a nitrogen-carbon bond.

The method of how the carbon coating layer 114 covers the silicon particles 112 is not particularly limited, and the carbon coating layer 114 can, for instance, partially or comprehensively cover the one or a plurality of silicon particles 112. The carbon coating layer 114 can be configured to restrain the volume of the silicon particles 112 from excessive expansion and lower the crushing rate of the silicon particles 112, and increase the conductivity of silicon via nitrogen doping.

The particle size of the N-doped Si/C composite 100 is not particularly limited, and only need to be uniform such that the N-doped Si/C composite 100 can be readily coated in a subsequent manufacture of the anode material of the lithium ion battery. In terms of obtaining a better coating effect, the particle size of the N-doped Si/C composite 100 can be between 0.5 microns and 40 microns. If the particle size is too small, the particle stacking density is prone to be insufficient, and if the particle size is too large, the coating surface is uneven.

The shape of the N-doped Si/C composite 100 is not particularly limited, and can be, for instance, circular or an irregular shape.

It should be mentioned that, the N-doped Si/C composite 100 has the silicon-nitrogen bond (94 eV to 108 eV) and the nitrogen-carbon bond. The nitrogen-carbon bond can be pyridinic N (398.1 eV to 399.3 eV), pyrrolic N (399.8 eV to 401.2 eV), or graphitic-N (401.1 eV to 402.7 eV). Moreover, a carbon-silicon bond can also be present in the carbon-silicon particles 120.

The nitrogen content of the N-doped Si/C composite 100 can be 0.05 wt % to 10 wt %, preferably 3 wt % to 5 wt %. When the nitrogen content is less than 0.05 wt %, the charge-discharge efficiency, cyclic stability, and conductivity of the N-doped Si/C composite 100 cannot be effectively increased. When the nitrogen content is greater than 10 wt %, preparation is not simple, and the cost is too high, and industrial applicably is not satisfactory.

Based on the N-doped Si/C composite of the present embodiment, an anode material for a lithium ion battery having good charge-discharge efficiency, high cyclic stability, and high conductivity can be provided.

The manufacturing method of the N-doped Si/C composite 100 includes (a) a mixing step in which a nitrogen-containing precursor, a carbon source, and a silicon source are mixed to provide a mixture; and (b) a sintering step in which the mixture is sintered in an inert atmosphere to obtain a N-doped Si/C composite.

Regarding the (a) mixing step, the method of forming the mixture can be solid-phase mixing, liquid-phase mixing, or solid-liquid mixing. Moreover, the temperature and pressure of the mixing are not particularly limited, and can be suitably adjusted as needed. In terms of operational convenience, the method of forming the mixture can be performed at atmospheric pressure and room temperature without an additional process to achieve the effect of nitrogen doping.

The nitrogen-containing precursor can be a solid-phase nitrogen-containing precursor. The nitrogen-containing precursor can be an organic nitrogen-containing precursor or an inorganic nitrogen-containing precursor. The organic nitrogen-containing precursor can specifically include hexamethylenetetramine (C₆H₁₂N₄), ammonium benzoate (C₆H₅COONH₄), ammonium citrate (HOC(CO₂NH₄)(CH₂CO₂NH₄)₂), ammonium formate (NH₄HCO₂), naphthonitrile (C₁₁H₇N), melamine (C₃H₆N₆), naphthalenedicarbonitrile (C₁₀H₆(CN₂)), 1,8-naphthalimide (C₁₂H₇NO₂), ammonium oxalate ((NH₄)₂C₂O₄), ammonium carbonate ((NH₄)₂CO₃), and ammonium nitrate (NH₄NO₃). The inorganic nitrogen-containing precursor can specifically include ammonium carbonate ((NH₄)₂CO₃) and ammonium nitrate (NH₄NO₃). The nitrogen-containing precursors can be used alone or in a combination of two or more.

In terms of nitrogen-doping efficiency, the nitrogen-containing precursor is preferably at least one selected from the group consisting of hexamethylenetetramine (C₆H₁₂N₄) and melamine (C₃H₆N₆). Here, the nitrogen-doping efficiency is the unit weight percentage of the nitrogen content in the N-doped Si/C composite relative to the nitrogen-containing precursor used in the preparation. The nitrogen-doping efficiency is not necessarily proportional to the nitrogen atom quantity in the nitrogen-containing precursor of a single molecule, but is related to the readiness of degradation of molecules in the sintering step. In general, if more ammonia is produced after degradation of molecules, then the nitrogen-doping efficiency is better.

The carbon source is not particularly limited, and only needs to be a compound with residual carbon via a heat treatment, and can specifically include, for instance, a polymer compound such as glucose, sucrose, phenolic resin, styrene resin, polyvinyl alcohol, polyvinyl chloride, polyvinyl acetate, or poly butyral; pitch such as ethylene heavy-end pitch, coal tar pitch, petroleum pitch, coal-tar pitch, or asphalt decomposition pitch; or polysaccharide such as starch or cellulose. The carbon sources can be used alone or in a combination of 2 or more.

The silicon source is not particularly limited, and only needs to be able to provide silicon, and can specifically include, for instance, free silicon powder (such as nano-grade silicon powder or micron-grade silicon powder), solar energy recycled silicon waste, wafer thinning mortar, silicon oxide, silicon source of abandoned plants, silicon carbide, and carbon-coated silicon. The silicon sources can be used alone or in a combination of 2 or more.

The weight ratio of the nitrogen-containing precursor and the carbon in the carbon source is 1 to 30, preferably 5 to 30. If the weight ratio of the nitrogen-containing precursor and carbon is less than 1, then nitrogen cannot be doped in the carbon-silicon particles, and nitrogen-doping effect is poor, and if the weight ratio of the nitrogen-containing precursor and carbon is over 30, then the cost is too high which is not conducive to commercialization.

The weight ratio of the carbon in the carbon source and the silicon in the silicon source is 0.01 to 1, preferably 0.10 to 0.20, and more preferably 0.12 to 0.17. If the weight ratio of the carbon and the silicon is less than 0.01, then the carbon coating layer cannot effectively achieve the function of restraining the volume of the silicon from excessive expansion and lowering the crushing rate of the silicon particles and increasing the conductivity of silicon via nitrogen doping. If the weight ratio of the carbon and the silicon is greater than 1, then the carbon coating layer is too thick, and lithium ions are not readily transferred as a result.

In terms of mixing uniformity, the mixture preferably further includes a solvent. The solvent is not particularly limited, and only needs to allow uniform dispersion of the nitrogen-containing precursor, the carbon source, and the silicon source without reacting with the nitrogen-containing precursor, the carbon source, and the silicon source. Specifically, the solvent can include a ketone solvent such as acetone; ether solvent such as ether; alcoholic solvent such as methanol, ethanol, or propanol; ester solvent such as methyl acetate, butyl acetate, ethyl acetate, isopropyl acetate, amyl acetate, or isoamyl acetate; benzene solvent such as benzene or toluene; N-methyl-2-pyrrolidone (NMP), gasoline, kerosene, n-hexane, or carbon tetrachloride. The solvents can be used alone or in a combination of 2 or more.

When a solvent is used, the nitrogen precursor, carbon source, and silicon source can be mixed in a solvent together, or the nitrogen-containing precursor, carbon source, and silicon source are respectively mixed in the solvent, and then the solvents in which the nitrogen-containing precursor, carbon source, and silicon source are respectively mixed are combined. The mixing method includes, for instance, using a stirrer or an ultrasonic oscillation method to increase the uniformity of the mixture. Next, the solvent is removed via heat drying or oven drying.

Regarding the (b) sintering step, the sintering method includes, for instance, placing the mixture in a crucible and then sintering via a high-temperature furnace.

The inert atmosphere is to prevent the carbon source from oxidation and forming carbon monoxide or carbon dioxide. The inert atmosphere can be nitrogen, hydrogen/nitrogen, or argon/nitrogen.

The sintering time is 0.5 hours to 10 hours. The sintering temperature only needs to completely carbonize the carbon source, and the sintering temperature can be 300° C. or more, preferably 300° C. to 1000° C. When the sintering temperature is less than 300° C., the carbon source cannot be completely carbonized, and when the sintering temperature is greater than 1000° C., the cost is too high, which is not desirable for commercialization.

In the sintering process, nitrogen atoms can be bonded to the dangling bonds of the silicon particles to achieve the effect of nitrogen doping, and at the same time, nitrogen can also be bonded to the carbon coating layer covering the silicon particles. Via such method, nitrogen can be bonded to carbon and silicon at the same time such that the N-doped Si/C composite has higher conductivity.

The manufacturing method can simply and effectively change silicon into nitrogen-doped silicon to increase the conductivity thereof, and at the same time, the structure between the carbons is more complete. Moreover, the organic nitrogen-containing precursor and the inorganic nitrogen-containing precursor have the feature of low cost and is readily available, and therefore cost can be effectively reduced. In comparison to the traditional method of preparing silicon particles with smaller sizes via a ball mill method, in the present embodiment, the conductivity of the silicon particles is increased and volume expansion of the silicon particles is inhibited by carbon coating.

### <Manufacturing Method of the Anode Material for a Lithium Battery>

First, carboxymethyl cellulose (CMC) used as the adhesive and water used as the solvent are mixed by stirring and dissolved, and after complete dissolution, conductive materials (KS6 and Super P) are added to be dispersed by stirring for 30 minutes. Next, the N-doped Si/C composite is added to disperse and stir for 1 hour. Next, styrene-butadiene rubber (SBR) is added and stirring is performed for 30 minutes to form the slurry for an anode material. The slung is coated on a copper foil via a coating machine and placed in an oven for drying to form the anode material for a lithium battery. Lastly, the anode material can be assembled into a button cell for a half-cell electrochemical test.

The following experimental examples are provided to further describe the invention. However, it should be understood that, the experimental examples are only exemplary, and should not be construed to limit the implementation of the invention.

### EXPERIMENTAL EXAMPLE 1

1.4118 g of pitch and 0.7059 g of hexamethylenetetramine (HMT) were placed in 142 g of acetone, and the components were evenly stirred for 30 minutes to prepare the first solution. 4 g of recycled silicon powder (model: M1, from Guangyu Materials Co., Ltd.) was placed in 100 g of acetone, and ultrasonic vibration was performed to prepare a second solution. The first and second solutions were mixed, then ultrasonic vibration was performed on the solutions, and then the solutions were filtered and dried in an oven to form a mixture. Next, the mixture was placed in a high-temperature furnace and sintered at 1000° C. for 2 hours to obtain the N-doped Si/C composite of experimental example 1. In Table 1, “nitrogen-containing precursor/carbon” is the weight ratio of the nitrogen-containing precursor and the carbon in the carbon source (the carbon in the pitch is about 50 wt %).

### EXPERIMENTAL EXAMPLES 2 TO 5

In experimental examples 2 to 5, N-doped Si/C composites were respectively prepared using the same nitrogen-containing precursor, carbon source, silicon source, and solvent and steps as experimental example 1, and the difference is that the contents of the pitch and HMT were changed (as shown in Table 1).

### EXPERIMENTAL EXAMPLES 6 TO 9

In experimental examples 6 to 9, N-doped Si/C composites were respectively prepared using the same carbon source, silicon source, and solvent and steps as experimental example 1, and the difference is that the HMT was replaced with other nitrogen-containing precursors (as shown in Table 1).

### COMPARATIVE EXAMPLE 1

Comparative example 1 is recycled silicon powder containing a plurality of impurities, wherein the silicon powder surface is partially oxidized such that the XPS generates an oxygen signal.

### COMPARATIVE EXAMPLE 2

1.4118 g of pitch was placed in 141.18 g of acetone, and the mixture was uniformly stirred for 30 minutes to form a 1st solution. 4 g of recycled silicon powder was placed in 100 g of acetone and ultrasonic oscillation was performed to form a 2nd solution. The first and second solutions were mixed, then ultrasonic vibration was performed, and then the solutions were filtered and dried in an oven to form a mixture. Next, the mixture was placed in a high-temperature furnace and sintered at 1000° C. for 2 hours to obtain the carbon silicon composite material of comparative example 1.

### <Evaluation Methods>

a. Transmission Electron Microscope (TEM)

A TEM image was taken with the TEM (model: JEM2000FX II) made by a Japanese electronics company (JEOL).

b. X-Ray Photoelectron Spectroscopy (XPS)

The X-ray photoelectron spectrum was measured using an X-ray photoelectron spectroscope (model: K-Alpha) made by Thermo Fisher SCIENTIFIC.

c. Charge-Discharge Test

The cycle life diagram and 10-cycle charge and discharge schematic of the lithium ion battery were obtained using an equipment (model: BAT-750B) made by AcuTech Systems Co., Ltd.

d. AC Impedance Analysis

The semicircular shape in high-frequency regions was observed using an AC impedance analyzer (model: CHI 6273E) made by CH Instruments at a scanning frequency of 1 MHz to 10 MHz and a current of 0.1 A.

e. Cyclic Voltammogram

Testing was performed using an AC impedance analyzer (model: CHI 6273E) made by CH Instruments at a scan interval of 1.5 V to 0.05 V and a scan rate of 0.0001 V/s.

f. Four-Point Probe Method

To measure the resistance and conductivity of the pole plate surface, a four-point probe equipment (model: LRS4-T) made by KeithLink Technology Co., Ltd. was used, and measurement was performed with the four probes spaced apart at 1.6 mm from one another.

TABLE 1

| | | | Recycled | | | | Weight percentage (%) | | | |
|---|---|---|---|---|---|---|---|---|---|---|
| | | | silicon | Carbon/(carbon | Nitrogen-containing | Nitrogen-containing | of each element content | | | |
| | Nitrogen source/amount | Pitch | powder | and silicon) | precursor/pitch | precursor/carbon | measured by XPS | | | |
| | (g) | (g) | (g) | (weight ratio) | (weight ratio) | (weight ratio) | C | O | N | Si |
| Experimental | HMT/0.7059 | 1.4118 | 4 | 0.15 | 1:2 | 1:1 | 51.6 | 28.1 | 1.20 | 19.1 |
| example 1 | | | | | | | | | | |
| Experimental | HMT/0.7059 | 1.4118 | 4 | 0.15 | 5:2 | 5:1 | 54.7 | 23.5 | 3.70 | 18.1 |
| example 2 | | | | | | | | | | |
| Experimental | HMT/0.7059 | 1.4118 | 4 | 0.15 | 10:2 | 10:1 | 54.9 | 24.3 | 3.20 | 17.6 |
| example 3 | | | | | | | | | | |
| Experimental | HMT/0.7059 | 1.4118 | 4 | 0.15 | 20:2 | 20:1 | 62.4 | 19.7 | 3.98 | 14.0 |
| example 4 | | | | | | | | | | |
| Experimental | HMT/0.7059 | 1.4118 | 4 | 0.15 | 30:2 | 30:1 | 67.9 | 16.4 | 4.03 | 11.7 |
| example 5 | | | | | | | | | | |
| Comparative | Recycled silicon powder | — | 4 | — | — | — | 14.6 | 45.9 | 0.7 | 38.8 |
| example 1 | | | | | | | | | | |
| Comparative | — | 1.4118 | 4 | 0.15 | — | — | | | | |
| example 2 | | | | | | | | | | |
| Experimental | (NH₄)₂CO₃/ | 1.4118 | 4 | 0.15 | 5:2 | 5:1 | 44.1 | 32.5 | 0.84 | 22.7 |
| example 6 | 0.7059_{—} | | | | | | | | | |
| Experimental | (NH₄)₂C₂O₄•H₂O/0.7059 | 1.4118 | 4 | 0.15 | 5:2 | 5:1 | 46.9 | 31.5 | 0.55 | 21.1 |
| example 7 | | | | | | | | | | |
| Experimental | NH₄HCO₂/0.7059 | 1.4118 | 4 | 0.15 | 5:2 | 5:1 | 44.5 | 32.6 | 1.01 | 21.9 |
| example 8 | | | | | | | | | | |
| Experimental | C₃H₆N₆/0.7059 | 1.4118 | 4 | 0.15 | 5:2 | 5:1 | 55.3 | 24.1 | 4.02 | 16.6 |
| example 9 | | | | | | | | | | |

### <Evaluation Results>

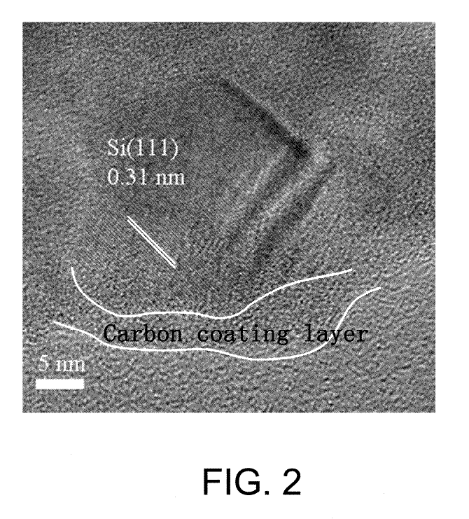

FIG. 2 is the transmission electron microscope (TEM) image of experimental example 1. According to FIG. 2, the N-doped Si/C composite contains a plurality of carbon-silicon particles, wherein the carbon coating layer partially or completely covers one or a plurality of silicon particles. FIG. 2 shows the Si(111) face of the silicon particles and the carbon coating layer covering the silicon particles. Moreover, in FIG. 2, 0.31 nm refers to the spacing between the two yellow lines.

It can be known from experimental examples 1 to 5 of Table 1 that, the weight ratio of the nitrogen-containing precursor and the carbon in the carbon source is 1 to 30, and the weight percentage of the nitrogen content of the N-doped Si/C composite is 1.20% or more. It can be known from experimental examples 1 to 5 of Table 2 that, when the weight ratio of the nitrogen-containing precursor and the carbon in the carbon source is 5 to 30, the weight percentage of the nitrogen content of the N-doped Si/C composite can be further increased to 3.70% or more. It should be mentioned that, considering nitrogen-doping efficiency and cost, experimental example 2 is the preferred experimental example among experimental examples 1 to 5. Moreover, in experimental example 2, a N-doped Si/C composite with high structural integrity and high thermal conductivity efficiency (high conductivity) can be obtained.

Moreover, it can be known from experimental example 2 and experimental examples 6 to 9 of Table 1 that, when the nitrogen-containing precursor is HMT or melamine, better nitrogen-doping effect is achieved.

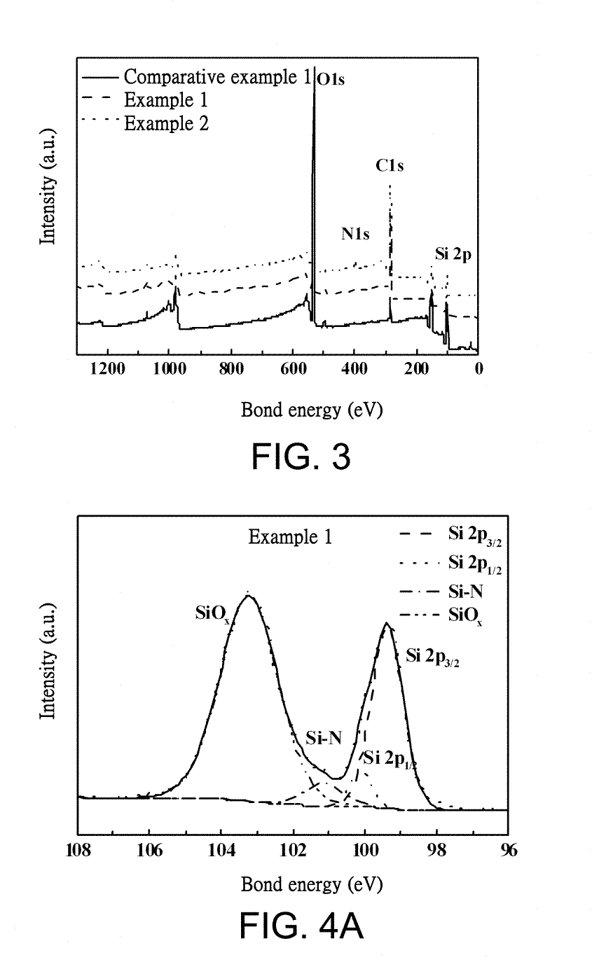

According to FIG. 3, in comparison to comparative example 1, experimental example 1 and experimental example 2 further contain a nitrogen signal, indicating the nitrogen content of the composite can be increased after the nitrogen-containing precursor was added in experimental examples 1 and 2.

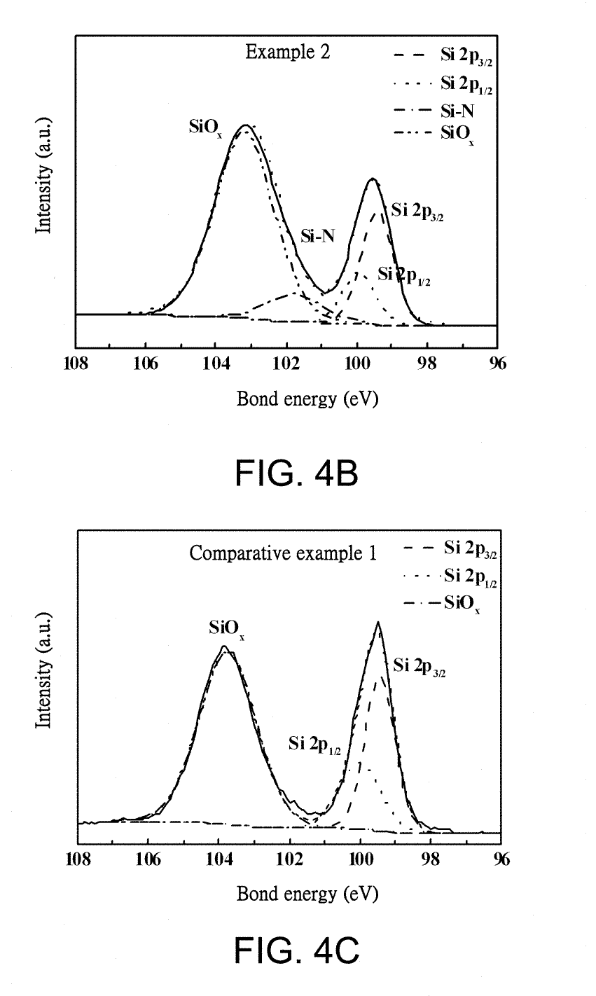

According to FIG. 4A to FIG. 4C, in comparison to comparative example 1 without a silicon-nitrogen bond, in experimental examples 1 and 2, the silicon-silicon bond is decreased and the silicon-nitrogen bond (94 eV to 108 eV) is formed. Therefore, it is seen that the bonding method is changed from silicon-silicon bond to silicon-nitrogen bond.

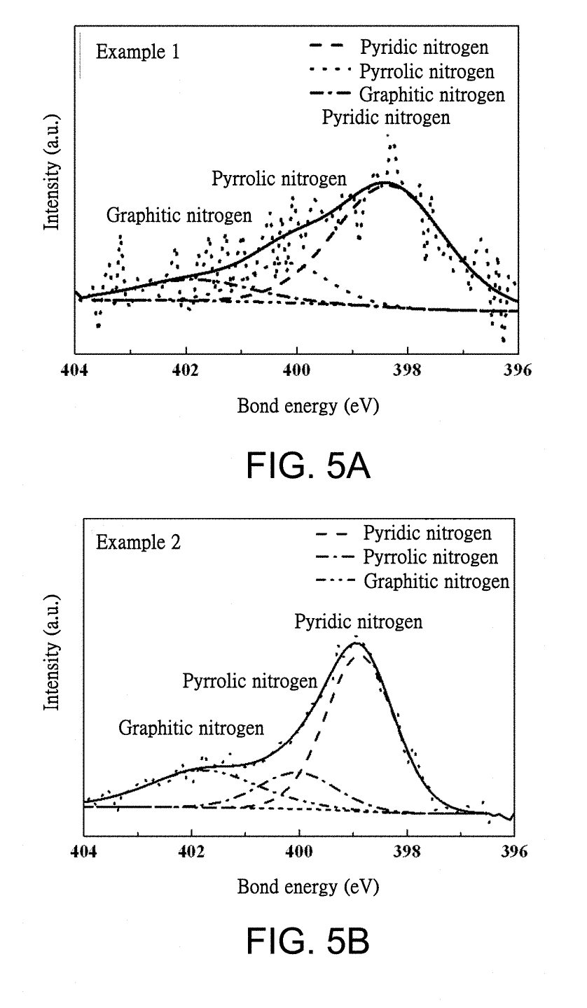

According to FIG. 5A and FIG. 5B, in experimental example 1 and experimental example 2, a nitrogen-carbon bond such as pyridinic N (398.1 eV to 399.3 eV), pyrrolic N (399.8 eV to 401.2 eV), and graphitic-N (401.1 eV to 402.7 eV) is present.

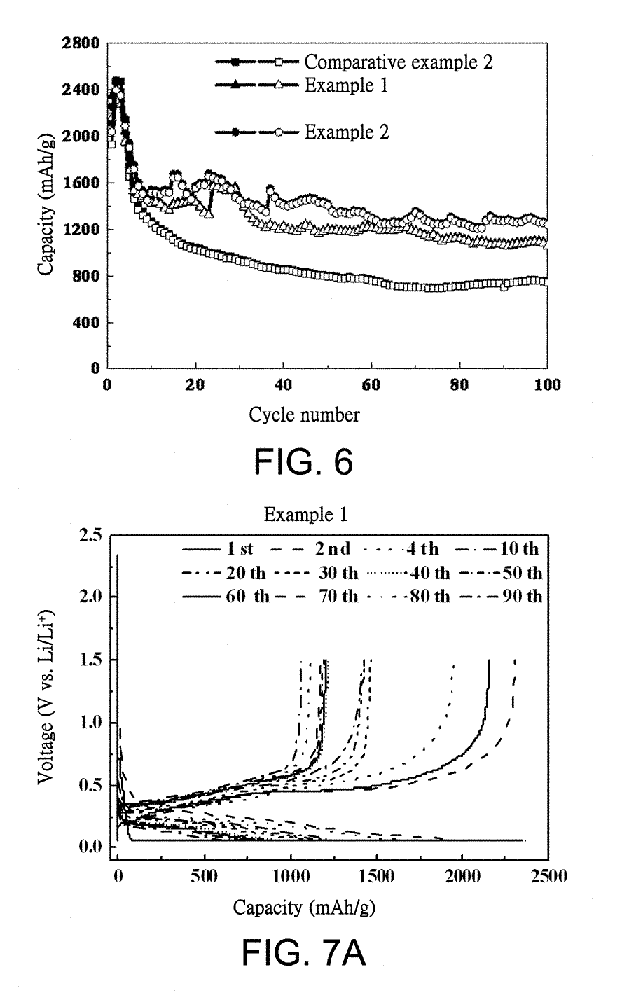

According to FIG. 6, after repeated battery cycles, the lithium ion batteries of experimental example 1 and experimental example 2 for which the carbon-silicon particles are doped with nitrogen have a higher capacitance than comparative example 1 for which the carbon-silicon particles are not doped with nitrogen. Therefore, the cycle life of the lithium ion battery can indeed be increased by using the N-doped Si/C composite.

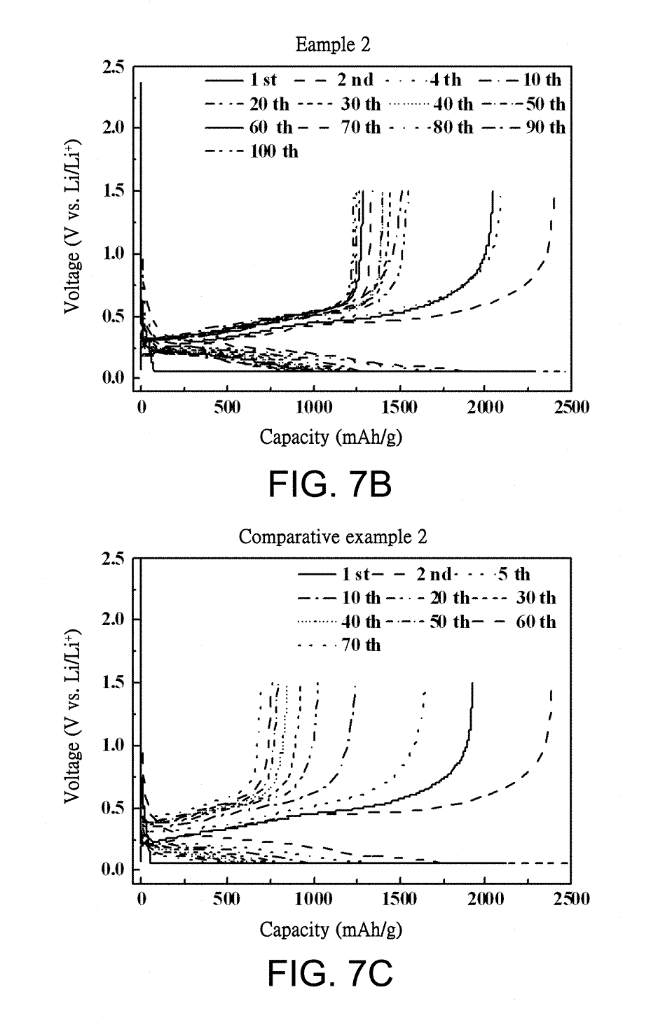

According to FIG. 7A, FIG. 7B and FIG. 7C, in comparison to the wider spacing of the charge and discharge curve of the lithium battery of comparative example 1, the spacing of the charge and discharge curves of the lithium batteries of experimental example 1 and experimental example 2 is closer, and the charge and discharge curves are not changed by an increase in the charge and discharge laps, and the potential needed for charging is also not increased. Therefore, by using the N-doped Si/C composite, not only can the polarization phenomenon of the lithium ion battery be significantly improved, cyclic stability of the lithium ion battery can also be increased.

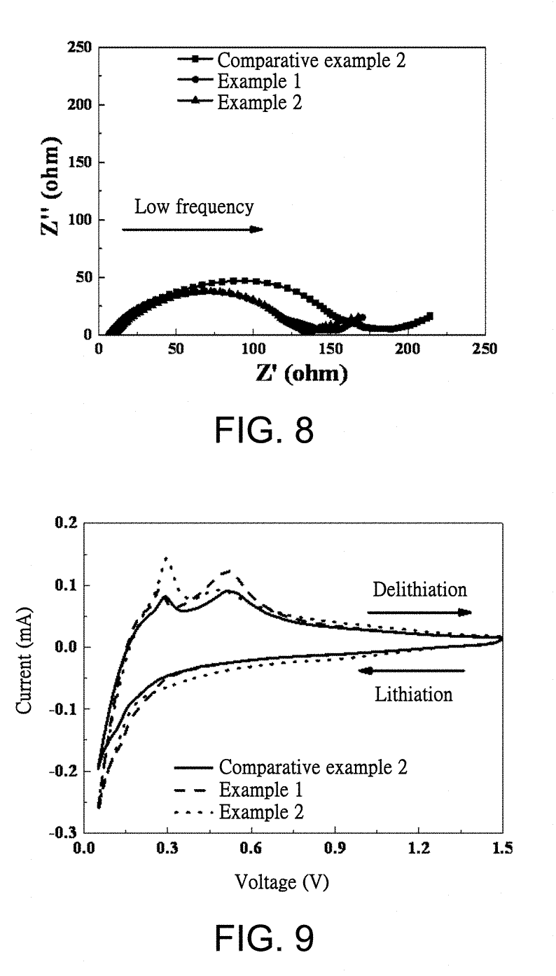

According to FIG. 8, in comparison to the impedance value of 188 Ohm of comparative example 1, the impedance values of experimental example 1 and experimental example 2 are reduced to 150 Ohm or less. Therefore, the impedance of the lithium ion battery can be reduced by using the N-doped Si/C composite, such that the battery can more readily charge and discharge (lithium ions are readily moved in or out), and therefore the charge and discharge efficiency is good.

According to FIG. 9, in comparison to the cyclic voltammogram of comparative example 1, the oxidation peak and reduction peak of the cyclic voltammograms of experimental example 1 and experimental example 2 are more significant (greater oxidation and reduction reaction currents). Therefore, when the N-doped Si/C composite is used as the anode material of the lithium ion battery, lithium ions can be better moved in or out such that the battery can more readily charge and discharge, and therefore the charge and discharge efficiency is good.

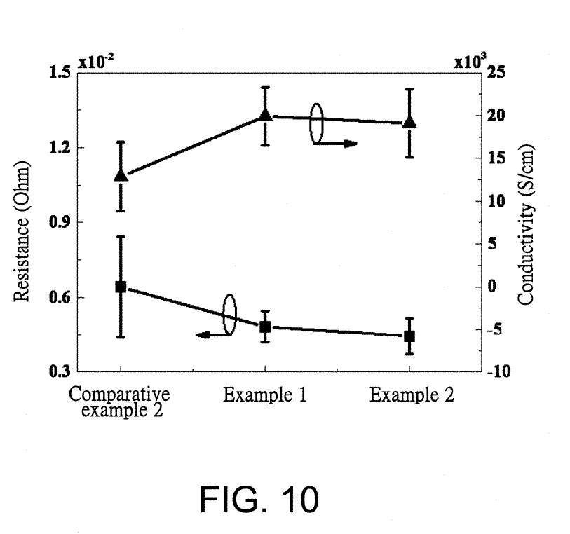

According to FIG. 10, in comparison to the impedance value of 188 Ohm of comparative example 1, the impedance values of experimental example 1 and experimental example 2 are respectively 150 Ohm and 135 Ohm. Therefore, when the N-doped Si/C composite is used as the anode material of a lithium ion battery, resistance can be reduced. Moreover, in comparison to the conductivity of 12850 S/cm of comparative example 1, the conductivities of experimental example 1 and experimental example 2 are respectively 19922 S/cm and 19100 S/cm. Therefore, when the N-doped Si/C composite is used as the anode material of a lithium ion battery, conductivity can be increased.

Based on the above, the invention provides a N-doped Si/C composite. By doping the silicon particles or the carbon coating layer in the carbon-silicon particles with nitrogen, the charge-discharge efficiency, cyclic stability, and conductivity of the composite can be increased. The invention further provides a manufacturing method of a N-doped Si/C composite. A nitrogen-containing precursor, a carbon source, and a silicon source are mixed and sintered to obtain the N-doped Si/C composite.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A N-doped Si/C composite comprising: a plurality of carbon-silicon particles,
each of the plurality of carbon-silicon particles comprises one or more silicon particles and a carbon coating layer covering the one or more silicon particles, wherein a plurality of first nitrogen atoms is distributed in the one or more silicon particles of each of the carbon-silicon particles via a silicon-nitrogen bond, and a plurality of second nitrogen atoms is distributed in the carbon coating layer of each of the carbon-silicon particles via a nitrogen-carbon bond.

2. The N-doped Si/C composite of claim 1, wherein the nitrogen-carbon bond is pyridinic N, pyrrolic N, or graphitic-N.

3. The N-doped Si/C composite of claim 1, wherein a peak position of the silicon-nitrogen bond in a silicon bond graph measured by a X-ray photoelectron spectroscopy is 94 eV to 108 eV.

4. The N-doped Si/C composite of claim 1, wherein a nitrogen content of the N-doped Si/C composite is 0.05 wt % to 10 wt %.

5. A manufacturing method of a N-doped Si/C composite, comprising:
mixing the nitrogen-containing precursor, the carbon source, and the silicon source to provide a mixture; and
sintering the mixture in an inert atmosphere to obtain the N-doped Si/C composite,
wherein the N-doped Si/C composite comprises a plurality of carbon-silicon particles,
each of the plurality of carbon-silicon particles comprises one or more silicon particles and a carbon coating layer covering the one or more silicon particles, wherein a plurality of first nitrogen atoms is distributed in the one or more silicon particles of each of the carbon-silicon particles via a silicon-nitrogen bond, and a plurality of second nitrogen atoms is distributed in the carbon coating layer of each of the carbon-silicon particles via a nitrogen-carbon bond.

6. The manufacturing method of the N-doped Si/C composite of claim 5, wherein the nitrogen-containing precursor is at least one selected from the group consisting of hexamethylenetetramine (C₆H₁₂N₄), ammonium benzoate (C₆H₅COONH₄), ammonium citrate (HOC(CO₂NH₄)(CH₂CO₂NH₄)₂), ammonium formate (NH₄HCO₂), naphthonitrile (C₁₁H₇N), melamine (C₃H₆N₆), naphthalenedicarbonitrile (C₁₀H₆(CN₂)), 1,8-naphthalimide (C₁₂H₇NO₂), ammonium oxalate ((NH₄)₂C₂O₄), ammonium carbonate ((NH₄)₂CO₃), and ammonium nitrate (NH₄NO₃).

7. The manufacturing method of the N-doped Si/C composite of claim 5, wherein the nitrogen-containing precursor is at least one selected from hexamethylenetetramine (C₆H₁₂N₄) and melamine (C₃H₆N₆).

8. The manufacturing method of the N-doped Si/C composite of claim 5, wherein the silicon source is at least one selected from the group consisting of silicon powder, solar energy recycled silicon waste, wafer thinning mortar, silicon oxide, silicon source of abandoned plants, silicon carbide, and carbon-coated silicon.

9. The manufacturing method of the N-doped Si/C composite of claim 5, wherein a weight ratio of a carbon in the carbon source and a silicon in the silicon source is 0.01 to 1.

10. The manufacturing method of the N-doped Si/C composite of claim 5, wherein a weight ratio of the nitrogen-containing precursor and a carbon in the carbon source is 1 to 30.

11. The manufacturing method of the N-doped Si/C composite of claim 5, wherein a weight ratio of the nitrogen-containing precursor and a carbon in the carbon source is 5 to 30.
